(19) United States
(12) Patent Application Publication
(10) Pub. No.: US 2017/0270159 A1
(43) Pub. Date: Sep. 21, 2017

(54) DETERMINING QUERY RESULTS IN RESPONSE TO NATURAL LANGUAGE QUERIES

(71) Applicant: Google Inc., Mountain View, CA (US)

(72) Inventors: Bo Wang, Mountain View, CA (US); Pravir Kumar Gupta, Mountain View, CA (US); Omer Bar-or, Mountain View, CA (US); Vishaal Kapoor, North Vancouver (CA); David Peter Whipp, San Jose, CA (US); Nitin Mangesh Shetti, Sunnyvale, CA (US); Michael Buchanan, Mountain View, CA (US); Bruce Christensen, Mountain View, CA (US); Cheng Li, Sunnyvale, CA (US)

(73) Assignee: Google Inc., Mountain View, CA (US)

(21) Appl. No.: 14/024,262

(22) Filed: Sep. 11, 2013

Related U.S. Application Data
(60) Provisional application No. 61/784,471, filed on Mar. 14, 2013.

(51) Int. Cl. G06F 17/30

(52) U.S. Cl. CPC G06F 17/30401

(57) ABSTRACT

Methods, systems, and apparatus, including computer programs encoded on computer storage media, for determining query results in response to queries. One of the methods includes obtaining first query results that are responsive to a first query; determining that the first query results do not satisfy a requirement; obtaining one or more modified queries for the first query; selecting a modified query from the one or more modified queries; obtaining second query results that are responsive to the selected modified query; analyzing the second query results and the first query results; determining to provide one or more second query results as a result of the analyzing; and providing the one or more second query results.

### BACKGROUND

This specification relates generally to providing query results in response to queries.

A search engine receives queries, for example, from one or more users and returns query results responsive to the queries. For example, the search engine can identify resources responsive to a query, generate query results with information about the resources, and cause the presentation of the query results corresponding to the resources in response to the query. Each search result can include, for example, a title of the resource, an address, e.g., URL, of the resource, and a snippet of content from the resource. Some queries can be better satisfied by directly providing information from resources responsive to the queries.

### SUMMARY

This specification describes technologies relating to determining query results in response to queries.

In general, one innovative aspect of the subject matter described in this specification can be embodied in methods that include the actions of obtaining first query results that are responsive to a first query; determining that the first query results do not satisfy a requirement; obtaining one or more modified queries for the first query; selecting a modified query from the one or more modified queries; obtaining second query results that are responsive to the selected modified query; analyzing the second query results and the first query results; determining to provide one or more second query results as a result of the analyzing; and providing the one or more second query results.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In particular, one embodiment may include all the following features in combination.

The methods can further include determining that the first query contains at least a threshold number of terms. The methods can further include selecting more than one modified query from the modified queries, and obtaining second query results that are responsive to the selected modified queries.

The requirement is selected from the group consisting of a first query result of the first query results is associated with a ranking score that satisfies a threshold score, the first query results include a high quality answer, wherein the high quality answer includes a first threshold number of first query results, and the first query results include a medium quality answer that is associated with a query intent of the first query, wherein the medium quality answer includes a second threshold number of first query results. The first threshold number is determined from a category associated with the high quality answer. The second threshold number is determined from a category associated with the medium quality answer.

The methods can further include obtaining a confidence score for each of the one or more modified queries. Selecting a modified query from the one or more modified queries can include selecting the modified query based on the confidence scores for each of the one or more modified queries.

Analyzing the second query results and the first query results can include determining that a second query result of the second query results is associated with a ranking score that is greater than ranking scores associated with the first query results.

Analyzing the second query results and the first query results can include determining that the second query results include an answer that is associated with a query intent of the first query.

Providing the one or more second query results can include presenting a hybrid list of query results, wherein the hybrid list includes query results from the first query results and the second query results.

Obtaining the one or more modified queries for the query can include determining a plurality of documents associated with the first query; determining a plurality of candidate modified queries, wherein each of the plurality of candidate modified queries is associated with at least one of the plurality of documents and each of the plurality of documents is associated with at least one of the plurality of candidate modified queries; determining, for each of the plurality of candidate modified queries, a score based on the relevance of the plurality of documents that are associated with the candidate modified query to the query; and identifying one or more modified queries from the plurality of candidate modified queries based on the scores. The plurality of documents corresponds to query results associated with the first query. The plurality of documents are HTML documents. Each of the plurality of documents is associated with a query result for a least one of the plurality of candidate modified queries. Each of the plurality of candidate modified queries has associated query results that include at least one of the plurality of documents. Each of the plurality of candidate modified queries is a popular query for at least one of the plurality of documents. The score is based on the proportion of the plurality of documents that are associated with the candidate modified query. The methods can further include receiving a second query, wherein the second query is the same as the first query; and providing the one or more second query results in response to the second query, wherein a measure of time between receiving the first query and the second query is less than a threshold.

The subject matter described in this specification can be implemented in particular embodiments so as to realize one or more of the following advantages. Query results responsive to a query can be analyzed for a system to determine if an alternative formulation of the query would result in better query results for the user. Query results for the query and alternative formulations of the query can be compared for a system to determine the better query results to present to the user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example search system for providing query results responsive to queries.

FIG. 2 illustrates an example query results provider.

FIG. 3 illustrates an example method for determining query results in response to queries.

FIG. 4 illustrates an example query rewrite system.

FIG. 5 illustrates an example query rewrite module.

FIG. 6 illustrates an example entity identifier matching module.

FIG. 7 illustrates another example query rewrite module.

FIG. 8 illustrates an example method for generating modified queries.

FIG. 9 illustrates an example mapping of associations of documents and queries.

FIG. 10 illustrates another example method for generating modified queries.

Like reference numbers and designations in the various drawings indicate like elements.

### DETAILED DESCRIPTION

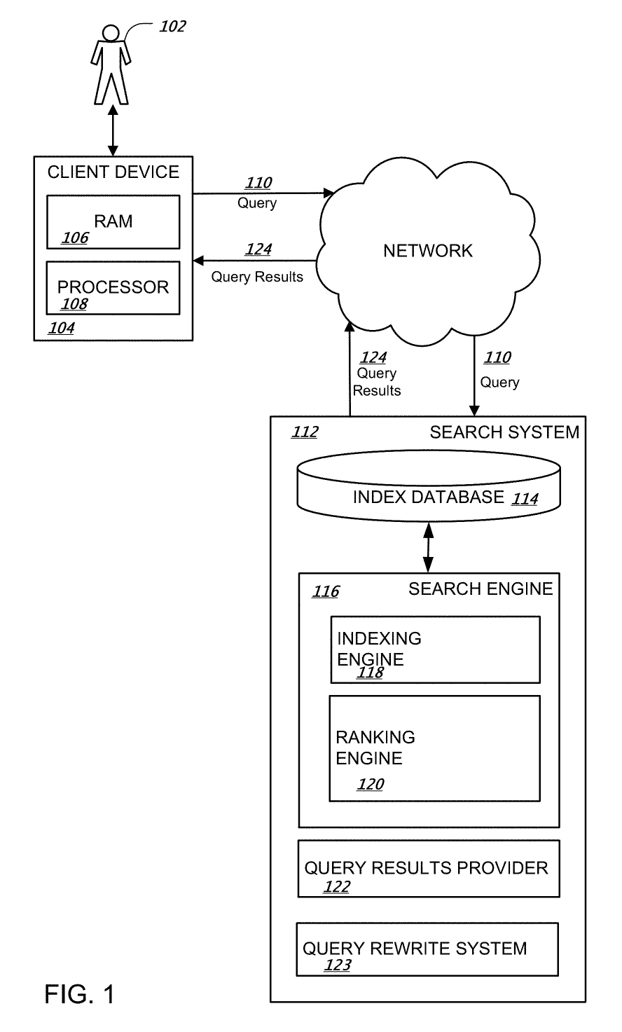

FIG. 1 illustrates an example search system 112 for providing query results responsive to queries as can be implemented for use in an Internet, an intranet, or another client and server environment. The search system 112 is an example of an information retrieval system in which the systems, components, and techniques described below can be implemented.

A user 102 can interact with the search system 112 through a client device 104. In some implementations, the client device 104 can communicate with the search system 112 over a network. For example, the client device 104 can be a computer coupled to the search system 112 through one or more wired or wireless networks, e.g., mobile phone networks, local area networks (LANs) or wide area network (WAN), e.g., the Internet. In some implementations, the client device 104 can communicate directly with the search system 112. For example, the search system 112 and the client device 104 can be implemented on one machine. For example, a user can install a desktop search system application on the client device 104. In some implementations, the search system 112 can be implemented as, for example, computer programs running on one or more computers in one or more locations that are coupled to each other through a network. The client device 104 will generally include a random access memory (RAM) 106, a processor 108, and one or more user interface devices, e.g., a display or speaker for output, and a keyboard, mouse, microphone, or touch sensitive display for input.

A user 102 can use the client device 104 to submit a query 110 to search system 112. The user can use the one or more user interface devices of the client device 104 to submit the query 110 to the search system 112. For example, the user 102 can interact with a user interface device to enter query 110 into a general user interface provided by the search system 112, e.g., a web page with a query text input field. Other methods of submitting queries to search engine 112 can also be performed. For example, the user 102 can submit the query 110 by speaking the query 110. An audio input device, e.g., microphone, associated with the client device 104 will detect the query 110 and transmit the query 110 to the search system 112. The query 110 can be submitted in natural language form, e.g., the language the user naturally writes or speaks in.

The search system 112 includes a search engine 116, an index database 114, and a query results provider 122.

Search engine 116 identifies resources that match query 110. The search engine 116 can be, for example, an Internet search engine that takes action or identifies answers based on user queries, a question and answer system that provides direct answers to questions posed by the user, or another system that processes user requests. The search engine 116 will generally include an indexing engine 118 and a ranking engine 120. Indexing engine 118 processes and updates resources, e.g., documents, web pages, images, or news articles on the Internet, found in a corpus, e.g., a collection or repository of content, in index database 114 using conventional or other indexing techniques. An electronic resource, which for brevity will simply be referred to as a resource, may, but need not, correspond to a file. A document may be stored in a portion of a file that holds other resources, in a single file dedicated to the resource in question, or in multiple coordinated files.

The ranking engine 120 uses the index database 114 to identify resources responsive to the query 110, for example, using conventional or other information retrieval techniques. The ranking engine 120 calculates scores for the resources responsive to the query, for example, using one or more ranking signals. Each signal provides information about the resource itself or the relationship between the resource and the query. One example signal is a measure of the overall quality of the resource. Another example signal is a measure of the number of times the terms of the query occur in the resource. Other signals can also be used. The ranking engine 120 then ranks the responsive resources using the scores.

The search system 112 uses the resources identified and scored by the ranking engine 116 to generate candidate query results. The candidate query results include results corresponding to resources responsive to the query 110. For example, a candidate query result can include a title of a resource, a link to the resource, and a summary of content from the resource that is responsive to the query. A query result is associated with a ranking score, for example, the ranking score of the resource that corresponds to the query result. In some implementations, candidate query results can be answers to the query. The answers include a summary of information responsive to the query. The summary can be generated from resources responsive to the query or from other sources. Different types of answers can be generated from resources responsive to the query or from other sources. For example, a type of answer that can be generated is an answer box. Answer boxes include information that can be provided as direct answers to the query 110 and are ranked with other query results based on the respective ranking scores associated with the answer boxes. There can be different categories of answer boxes based on the information provided by the answer box. For example, stock answer boxes provide stock information, weather answer boxes provide weather information, sports answer boxes provide sport score information, and currency conversion answer boxes provide currency conversion information. Answer boxes are presented to the user in a user interface that separates the answer box answer from other query results on the search results webpage of the search engine. For example, an answer box may be a distinct shaded box. The category of the answer box dictates how the information is presented in the answer box. For example, a stock answer box can provide a chart of stock price as a function of time, whereas a weather answer box can provide a graphical representation of the weather, e.g., a sun or clouds.

As a further example, another type of answer that can be generated is a universal answer. A universal answer can be a group of query results that correspond to resources of a particular category. Example categories include videos, images, news, and local. Universal answers are also ranked with other query results based on the respective ranking scores associated with the universal answers. There can be different categories of universal answers based on the category of resources that correspond to the query results included in the universal answer. For example, image universal answers include query results that correspond to image resources, news universal answers include query results that correspond to news resources, local universal answers include query results that correspond to local resources, and video universal answers include query results that correspond to video resources. For example, a video universal answer can be a grouping of query results that correspond to Britney Spears music videos in response to the query “Britney Spears.”

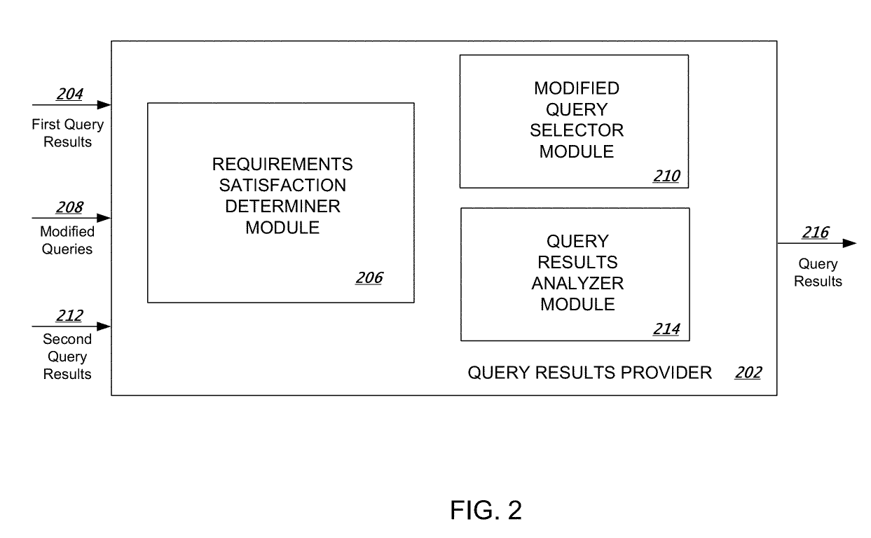

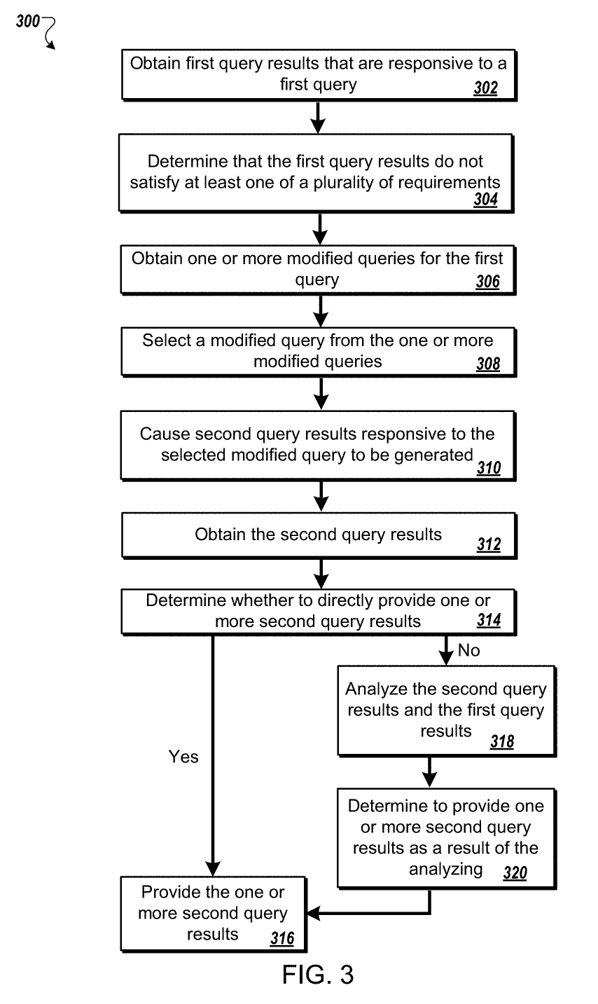

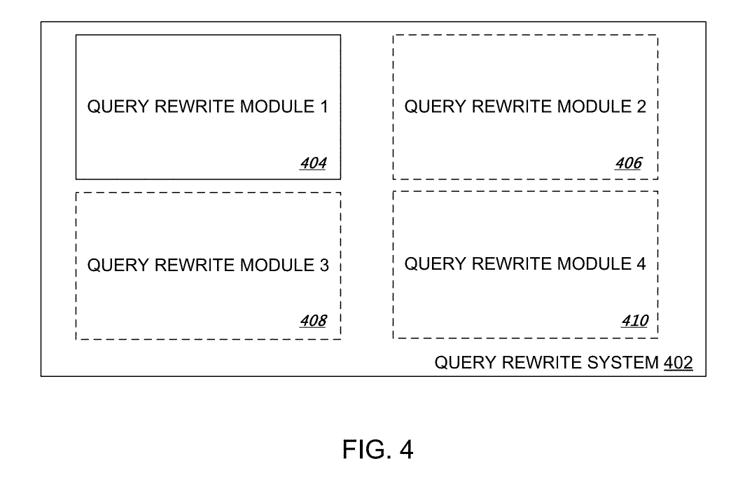

The query results provider 122 obtains one or more modified queries that are modifications of the original query 110 and selects at least one of the modified queries, as described in more detail below with reference to FIGS. 2 and 3. The modified queries are obtained from a query rewrite system 123, as described in more detail below with reference to FIG. 4. In some implementations, the query rewrite system can be distinct from the search system 112. For example, the search system 112 can communicate with the query rewrite system 123 over a network. In some implementations, the query rewrite system 123 can be included in the search system 112.

The search system 112 generates candidate query results that are responsive to the selected modified queries. The query results provider 122 analyzes the respective sets of candidate query results for the original query 110 and selected modified queries. Based on the analyses, the query results provider 122 determines the set of candidate query results to provide in response to the query 110, as described in more detail below with reference to FIGS. 2 and 3. The candidate query results that are provided in response to the query 110 are the query results 124 presented to the user 102.

The search system 112 transmits the query results 124 to the client device 104 for presentation to the user 102. The query results 124 are presented in an organized fashion to the user 102, e.g., a search engine results web page displayed in a web browser running on the client device. Query results that are answers to the query 110 can be presented in a manner distinct from how other query results are presented. For example, answers can be displayed as an answer box.

FIG. 2 illustrates an example query results provider. The query results provider 202 is an example of the query results provider 122 described above with reference to FIG. 1.

The query results provider 202 includes a requirements satisfaction determiner module 206, a modified query selector module 210, and a query results analyzer module 214. The query results provider 202 determines which query results to provide in response to a query.

The query results provider 202 receives first query results 204. The received first query results 204 are identified and ranked by a search system, as described above with reference to FIG. 1, in response to a query submitted by a user.

The requirements satisfaction determiner module 206 analyzes the first query results to determine if the first query results are satisfactory query results for the query. The requirements satisfaction determiner module 206 determines if the first query results are satisfactory query results by determining whether they satisfy predetermined requirements, as described in more detail below with reference to FIG. 3. One example predetermined requirement is that at least one first query result of the first query results is associated with a ranking score that satisfies, for example, meets or exceeds, a predetermined threshold ranking score. For example, the requirements satisfaction determiner module 206 determines that the first query results satisfy this predetermined requirement when one of the first query results has a ranking score that is greater than N, where N is a positive value. The first query results do not satisfy this predetermined requirement when none of the first query results has a ranking score that is greater than N. The requirements satisfaction determiner module 206 can use other predetermined requirements to determine if the first query results are satisfactory query results.

Another example predetermined requirement is that the first query results include at least one high quality answer. A high quality answer includes information that can be provided in response to the query with a high degree of certainty that the information satisfies the query. The certainty that an answer satisfies a query can be based on a relationship between the query and the answer. For example, the relationship between the query and the answer can be represented by the ranking score for the answer in response to the query. There is a high degree of certainty that answers with ranking scores that satisfy, e.g., meets or exceeds, a predetermined threshold score satisfy the query. In some implementations, high quality answers can include query results that correspond to resources responsive to the query. For example, query results can be determined to be high quality answers from the ranking scores for the query results. In some implementations, high quality answers do not include query results that correspond to resources responsive to the query. For example, high quality answers can include only answers to the query, e.g., answer boxes and universal answers. Different criteria can be used to determine whether answer boxes and universal answers are high quality answers. For example, the requirements satisfaction determiner module 206 identifies all answer boxes as high quality answers. Alternatively, the requirements satisfaction determiner module 206 identifies answer boxes that are of specific categories as high quality answers. For example, weather and stock answer boxes can be identified as high quality answers, whereas currency conversion and sports answer boxes are not identified as high quality answers. This can be because there is a higher degree of certainty that weather and stock answer boxes satisfy the respective queries that generate the answer boxes than currency conversion and sports answers boxes. The higher degree of certainty for certain categories of answer boxes can be based on a confidence that the category of answer box satisfies their respective queries. For example, human raters can identify certain categories of answer boxes as high quality answers based on the confidence for respective categories of answer boxes to satisfy their respective queries. Universal answers are identified as high quality answers based on the number of query results included in the universal answer. A universal answer that contains a number of query results that satisfies, for example, meets or exceeds, a predetermined high quality threshold number of query results is a high quality answer. For example, a universal answer that contains five query results when the predetermined high quality threshold number is four query results is a high quality universal answer. In some implementations, the predetermined high quality threshold number is based on the category of the query results included in the universal answer. For example, the predetermined high quality threshold number can be three video query results for a video universal answer whereas the predetermined threshold number can be five image query results for an image universal answer. The requirements satisfaction determiner module 206 determines that first query results with a high quality answer satisfy this predetermined requirement, whereas first query results that do not include a high quality answer do not satisfy this predetermined requirement.

For example, another predetermined requirement is that the first query results include at least one medium quality answer. A medium quality answer includes information that can be provided in response to the query with a lower degree of certainty than high quality answers that the information satisfies the query. In some implementations, medium quality answers can include query results that correspond to resources responsive to the query. For example, query results can be determined to be medium quality answers from the ranking scores for the query results. In some implementations, medium quality answers do not include query results that correspond to resources responsive to the query. For example, medium quality answers can include only answers to the query, e.g., answer boxes and universal answers. Different criteria can be used to determine whether answer boxes and universal answers are medium quality answers. For example, the requirements satisfaction determiner module 206 can identify all answer boxes as medium quality answers. Alternatively, the requirements satisfaction determiner module 206 can identify answer boxes that are of specific categories as medium quality answers. Universal answers are identified as medium quality answers based on the number of query results included in the universal answer. The requirements satisfaction determiner module 206 identifies universal answers as medium quality when they do not satisfy the predetermined high quality threshold number of query results, but satisfy a predetermined medium quality threshold number. For example, a universal answer that contains three query results and does not satisfy the predetermined high quality threshold number of four query results is not a high quality universal answer. However, the three query results satisfy a predetermined medium quality threshold number of two query results, and the universal answer is identified as a medium quality answer. In some implementations, the predetermined medium quality threshold number is based on the category of the query results in the universal answer, as described above.

In some implementations, the medium quality answer also has to be associated with a query intent of the query submitted by the user to satisfy the predetermined requirement. Query intents represent the intent of the user when submitting the query. The user's intent can be to search for a particular type of resource, for example, video, image, news, local, or weather resources. Therefore, example query intents can include “video,” “image,” “news,” “local,” and “weather.” In some implementations, the requirements satisfaction determiner module 206 receives query intents from a system that identifies query intents. In some implementations, the requirements satisfaction determiner module 206 identifies the query intents. The query intents can be identified from the query. The query can be matched with query templates. Each query template can be associated with one or multiple candidate query intents. The candidate query intents associated with the query templates that match the original query are identified as the intents of the query. An example query template is “*location of*” where the asterisks indicate that the terms “location of” can be surrounded by any other additional terms. Query template “*location of*” can be associated with the query intent “local.” An original query, e.g., “the location of The French Laundry,” can be determined to match the query template “*location of*.” Therefore, “local” is identified as an intent for the query “the location of The French Laundry.” In some implementations, whether a query matches a query template can be determined from a similarity between the original query and the query template. The similarity can be based on the similarity between the words and/or letters that identify the original query and the query template. For example, the query “the location of The French Laundry” has a higher degree of similarity with query template “*the location of*” than the query “locate The French Laundry.” The query templates that satisfy, for example, meet or exceed, a threshold level of similarity with the original query are matched with the original query.

The query results provider 202 receives information that identifies one or more intents of the query. Query results are associated with query intents that correspond to the category of the query result. For example, an answer box is associated with a query intent that corresponds to the category of the answer box. For example, “weather” query intents correspond to weather answer boxes and “local” query intents correspond to local answer boxes. As a further example, a universal answer is associated with a query intent that corresponds to the category of the universal answer. For example, “video” query intents correspond with video universal answers that contain query results that correspond to video resources. The requirements satisfaction determiner module 206 determines that first query results with a medium quality answer that is associated with a query intent satisfies this predetermined requirement. First query results that do not have a medium quality answer that matches a query intent do not satisfy this predetermined requirement.

The modified query selector module 210 selects one or more modified queries obtained by query results provider 202, as described in more detail below with reference to FIG. 3. In some implementations, the modified queries are generated from a query rewrite system. The query rewrite system generates modified queries from the original query submitted by the user, as described in more detail below with reference to FIG. 4. The query results provider 202 transmits the selected modified queries to a search system, for example, the search system 112 described above with reference to FIG. 1. The search system generates second query results for each of the selected modified queries, which are returned to the query results provider 202.

The query results analyzer module 214 analyzes the second query results for the selected modified queries and the first query results, as described in more detail below with reference to FIG. 3. From this analysis, the query results analyzer module 214 determines the set of query results to provide in response to the query 110. The query results are transmitted to the user's client device and presented to the user in response to the query.

FIG. 3 illustrates an example method for determining query results in response to queries. For convenience, the example method 300 will be described in reference to a system that performs method 300. The system can be, for example, the query results provider described above with reference to FIGS. 1 and 2. In some implementations, the system can include one or more computers.

The system obtains first query results that are responsive to a first query (302), as described above with reference to FIG. 1. In some implementations, queries submitted to a search engine by a user are analyzed to determine the number of terms in the query. In response to the determination that the first query does not contain at least a predetermined threshold number of terms, the first query results generated in response to the first query are directly transmitted for presentation to the user. The system takes no action on the first query results. In response to the determination that the first query contains at least the predetermined threshold number of terms, the system obtains the first query results and determines whether the first query results satisfy requirements.

The system determines that the first query results do not satisfy requirements (304). The requirements can include the requirements described above with reference to FIG. 2. If the system determines that the first query results do not satisfy the requirements, the system proceeds to cause alternative query results to be generated for the first query, for example, by the query rewrite system 123 described below with reference to FIG. 1. The system can determine that the first query results do not satisfy the requirements using different methods. In some implementations, the system determines that the first query results do not satisfy the requirements if the first query results do not satisfy all of the predetermined requirements. In some implementations, the system determines that the first query results do not satisfy the requirements if the first query results do not satisfy a minimum number of the plurality of predetermined requirements. The minimum number can be any integer value. For example, if the system determines that the first query results do not satisfy three of the requirements, the system proceeds to cause alternative query results to be generated for the first query.

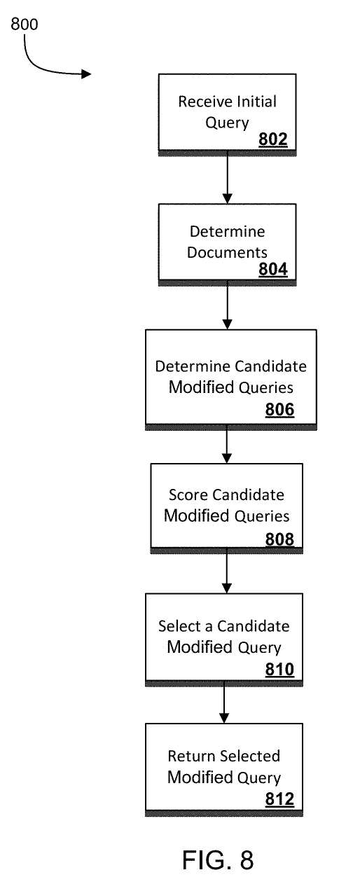

The system obtains one or more modified queries for the first query (306). The modified queries can be obtained from the query rewrite system. The query rewrite system can take a query submitted by a user in natural language, and generate one or more modified queries, as described in more detail below with reference to FIGS. 4-10. The modified queries can be alternative formulations of the query that are optimized for search engines. In some implementations, the query rewrite system can also generate one or more confidence scores associated with each of the modified queries it generates. The confidence score for a modified query indicates a level of confidence in the modified query as a rewrite of the first query. The confidence score can be based on characteristics of the first query and modified query. The confidence scores can be determined from query relevancy scores, as described below with reference to FIG. 8, as well as any other numeric or non-numeric expression of confidence. The confidence measures may also be a constant or some other measure modified by a constant. The system obtains the confidence scores for the modified queries it obtains.

In some implementations, the query rewrite system can include multiple query rewrite modules, as described in more detail below with reference to FIG. 4. Each query rewrite module can generate one or more modified queries from the first query. Each query rewrite module can be associated with a module quality score. The module quality score indicates a quality level of the associated module. In some implementations, the different modules can be manually rated by human raters based on the quality of the modified queries generated by the modules.

The system selects a modified query from the one or more modified queries (308). In some implementations, the system selects a modified query based on the confidence scores for each of the one or more modified queries. In some implementations, the system can select more than one modified query from the one or more modified queries. For example, the system selects the modified query or queries with the greatest associated confidence score. Alternatively, or additionally, the system selects the modified query or queries based on the module quality score associated with the query rewrite modules that generated the modified queries. For example, the system selects the modified query that was generated by the query rewrite module with the greatest module quality score. In some implementations, the system selects a modified query or queries based on a combination of the confidence scores for the generated modified queries and the respective module quality score associated with the query rewrite modules that generated the modified queries. The confidence score for a particular modified query can be combined with the module quality score associated with the query rewrite module that generated the particular modified query according to a function, for example, a linear (e.g., multiplicative or additive), exponential, logarithmic or power function. The system can select the modified query or queries with the greatest combined score.

The system causes second query results responsive to the selected modified query or queries to be generated (310). The system can cause a search system to generate the second query results. For example, the system can transmit the selected modified query to the search system, and the search system can generate the second query results, as described above with reference to FIG. 1.

The system obtains the second query results that are responsive to the selected modified query or queries (312). For example, the search system can transmit the second query results that it generated to the system.

The system determines whether to directly provide one or more second query results to the user (314). The system makes this determination based on a confidence that the user should be presented with the one or more second query results. The confidence can be based on different signals. The signals can include the confidence score for the modified query that the second query results were generated from and the module quality score for the query rewrite module that generated the modified query. The system can determine “Yes” to directly provide the one or more second query results based on the signals. For example, the system determines to directly provide the one or more second query results if the confidence score for the selected modified query satisfies, for example, meets or exceeds, predetermined threshold confidence score. Alternatively, the system determines to directly provide the one or more second query results if the module quality score for query rewrite module that generated the selected modified query satisfies, for example, meets or exceeds, a predetermined threshold module quality score. In some implementations, the system determines to directly provide the one or more second query results based on both the confidence score for the modified query that the second query results were generated from and the module quality score for the query rewrite module that generated the modified query. For example, the system determines to directly provide the one or more second query results if both the confidence score and the module quality score satisfy, for example, meets or exceeds, their respective predetermined threshold scores. Alternatively, or additionally, the system determines to directly provide the one or more second query results if a combination of the confidence score and the module quality score satisfies, for example, meets or exceeds, a predetermined threshold combined score.

If the system determines to directly provide the one or more second query results, then the system provides the one or more second query results (316). In some implementations, the one or more second query results can be provided with the first query results. A hybrid list of query results can be presented to the user, where the hybrid list includes query results from the first query results and the second query results. In some implementations, the hybrid list of query results only includes the second query results that are answers, e.g., universal answers and answer boxes. For example, the second query results that are answers are presented with the first query results. In some implementations, the hybrid list of query results includes a combination of second query results that are answers and other second query results. For example, the presented query results can include any query result from the first and second query results.

The system determines which second query results to provide based on the confidence score for the selected modified query and the quality score associated with the module that generated the selected modified query. For example, if the confidence score and the module quality score satisfy respective predetermined threshold scores, then any second query result can be provided to the user. If the confidence score and the module quality score do not satisfy respective predetermined threshold scores, then only the second query results that are answers are provided to the user.

In some implementations, the system provides only the second query results to the user. For example, the system determines that only the second query results are to be provided if the confidence score and the module quality score are sufficiently high.

If the system does not provide the one or more second query results, then the system determines “No” and does not directly provide the one or more second query results. The system analyzes the second query results and the first query results (318) and determines to provide one or more second query results as a result of the analyzing (320). In some implementations, the system analyzes the second query results and the first query results to determine that one of the second query results is associated with a ranking score that is greater than the ranking scores associated with the first query results. If the query result with the greatest associated ranking score between the first and second query results is a second query result, then the system determines to provide the one or more second query results. Alternatively, or additionally, the system determines to provide the one or more second query results by determining that the second query results include an answer that is associated with a query intent of the first query, as described above with reference to FIG. 2.

The system provides the one or more second query results (316), as described above.

In some implementations, the system selects multiple selected modified queries from the one or more modified queries. The system can select the multiple selected modified queries based on the confidence scores for each of the generated modified queries and the respective module quality score associated with the query rewrite modules that generated the modified queries, as described above. For example, the system can select a predetermined number of modified queries with the greatest combined confidence score and module quality score. Alternatively, the system can select all modified queries with a combined confidence score and module quality score that satisfies, for example, meets or exceeds, a predetermined threshold score. The system causes a set of second query results to be generated for each of the multiple selected modified queries and obtains the second query results. The system then determines whether to directly provide a set of the second query results based on a confidence that the user should be presented with the set of second query results, as described above. If the system determines that more than one set of second query results can be directly provided, the system can provide the set of second query results with the greatest confidence. If the system does not determine to directly provide a set of second query results, the system analyzes the different sets of second query results and the first query results. The system determines to provide the set of second query results that includes the query result with the greatest ranking score of the query results included in the sets of second query results and first query results. Alternatively, the system can determine to provide the set of second query results that includes a query result that is associated with a query intent of the first query. The system provides the set of second query results, as described above.

The system can perform the steps of method 300 in different temporal orders. In some implementations, the system obtains the modified queries and selects a modified query in response to determining that the first query results do not satisfy the requirements. In some implementations, the system obtains the modified queries and selects a modified query in parallel with the system determining that the first query results do not satisfy the requirements. In some implementations, the system obtains the modified queries, selects a modified query, and obtains the second query results responsive to the selected modified query in parallel with the system determining that the first query results do not satisfy the requirements.

FIG. 4 illustrates an example query rewrite system. The query rewrite system 402 is an example of the query rewrite system 123 described above with reference to FIG. 1.

The query rewrite system includes at least one query rewrite module, as illustrated by the first query rewrite module 404. The query rewrite system 402 can also include a number of optional query rewrite modules. FIG. 4 illustrates the query rewrite system 402 with three optional query rewrite modules—the second query rewrite module 406, the third query rewrite module 408, and the fourth query rewrite module 408.

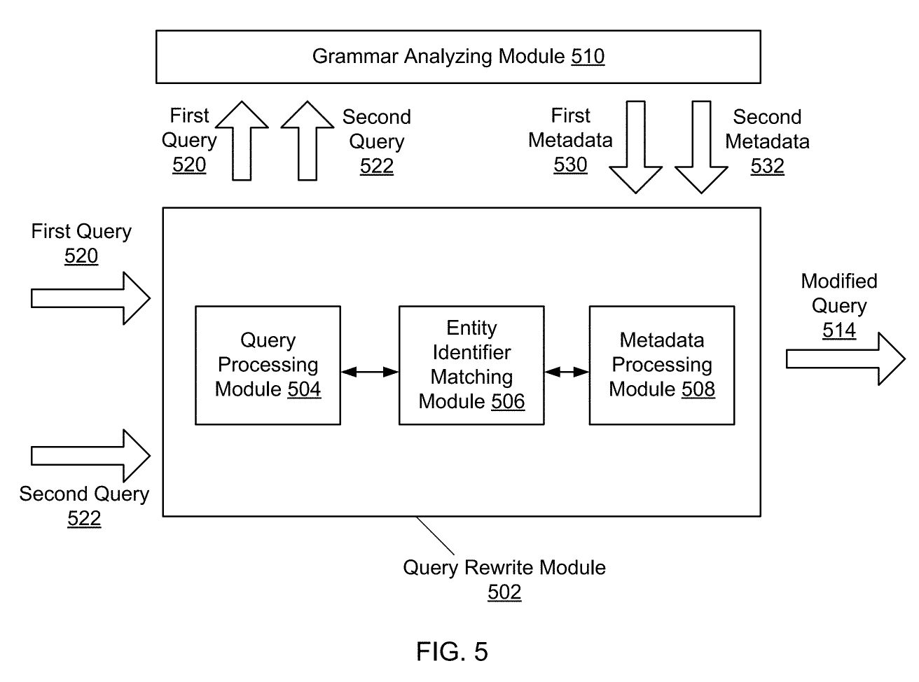

Each query rewrite module generates one or more modified queries from the original query using different methods. The query rewrite modules can also generate a confidence score for each of the modified queries that it generates. Each query rewrite module can also be associated with a module quality score, as described above with reference to FIG. 3. One or more of the generated modified queries are selected by the query results provider based on the confidence scores and the module quality scores, as described above with reference to FIG. 3. Example query rewrite modules are described in more detail below, with references to FIGS. 5-10.

FIG. 5 illustrates an example query rewrite module 502. The example query rewrite module 502 can be, for example, any of the query rewrite modules 404, 406, 408, and 410 described above with reference to FIG. 4. As shown in FIG. 5, the query rewrite module 502 can return modified queries based on a first query, that is, the query submitted by a user.

Some implementations have different and/or additional modules than those shown in FIG. 5. Moreover, the functionalities can be distributed among the modules in a different manner than described here.

The example query rewrite module 502 includes a query processing module 504, an entity identifier matching module 506, and a metadata processing module 508. In some implementations, the query processing module 504 receives a first query 520. As an example, the first query 520 includes an entity identifier. The query processing module 504 sends the first query 520 to a grammar analyzing module 510.

In some implementations, the query processing module 508 obtains an answer for the first query 520 described above with reference to FIG. 1. As an example, the answer for the first query 520 includes an entity identifier. The query processing module sends the first query 520 and/or the answer for the first query 520 to the grammar analyzing module 510.

The metadata processing module 508 receives a first metadata 530 from the grammar analyzing module 510. In some implementations, the first metadata 530 identifies an entity identifier of the first query 520. In some implementations, the first metadata 530 identifies an entity identifier of the answer for the first query 520. The first metadata 530 includes gender information of the entity identifier. The gender can be a male gender, a female gender, or a neuter gender. In some implementations, the first metadata 530 includes gender and number information (e.g., plurality) of the entity identifier. The gender (including number information) can be a plural male gender, a plural female gender, a plural mixed gender, and a plural neuter gender.

In some implementations, the query process module 504 receives a second query 522. As an example, the second query 522 includes a pronoun. The query processing module 504 sends the second query 522 to a grammar analyzing module 510.

The metadata processing module 508 receives a second metadata 532 from the grammar analyzing module 510. In some implementations, the second metadata 532 identifies the pronoun of the second query 522. The second metadata 532 includes gender information of the pronoun.

In some implementations, the entity identifier matching module 506 matches the entity identifier of the first query 520 to the pronoun of the second query 522 based on the first metadata 530 associated with the first query 520 and the second metadata 532 associated with the second query 522. As an example, the first query 520 contains an entity identifier and the second query 522 contains a pronoun. The entity matching module 506 compares the entity identifier of the first query 520 to the pronoun of the second query 522 and determines if there is a match between the entity identifier of the first query 520 and the pronoun of the second query 522 based on the gender of the entity identifier and the gender of the pronoun. In some implementations, there is a match when the gender of the entity identifier and the gender of the pronoun are the same.

In some implementations, if there is a match between the entity identifier of the first query 520 and the pronoun of the second query 522, then a modified query 514 is generated. In some implementations, the modified query 514 includes at least one term of the second query 522 and the entity identifier of the first query 520. In some implementations, the pronoun of the second query 522 is substituted with the entity identifier of the first query 520 to generate the modified query 514.

In some implementations, the first query 520 and the second query 522 are concatenated to generate a concatenated query. The concatenated query is sent to the grammar analyzing module 510. Metadata identifying the entity identifier of the concatenated query, the gender of the entity identifier, the pronoun of the concatenated query, and the gender of the pronoun are received by the metadata processing module 508. The entity identifier matching module 506 compares the gender of the entity identifier to the gender of the pronoun to determine a match between the entity identifier and the pronoun.

In some implementations, the second query 522 can be received within a threshold amount of time from the first query 520. The threshold amount of time ranges from a few seconds to a few hours. If the second query 522 is received within the threshold amount of time, then a modified query 514 is generated based on the matching of the entity identifier of the first query 520 and the pronoun of the second query 522.

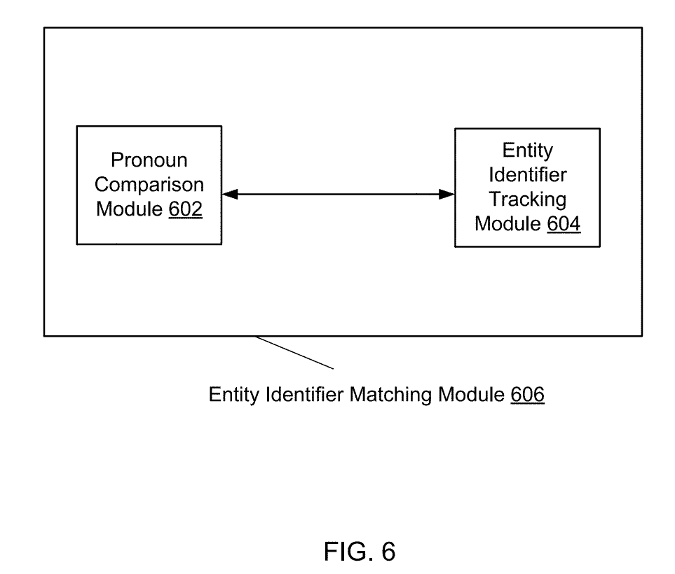

FIG. 6 illustrates an example entity identifier matching module 606. Some implementations have different and/or additional modules than those shown in FIG. 6. Moreover, the functionalities can be distributed among the modules in a different manner than described here.

The example entity identifier matching module 606 includes a pronoun comparison module 602 and an entity identifier tracking module 604. In some implementations, the entity identifier tracking module 604 records one or more entity identifiers of one or more queries and a gender of the one or more entity identifiers. The entity identifier tracking module 604 tracks and/or records one or more entity identifiers (e.g., a first entity identifier and a second entity identifier). In some implementations, the one or more entity identifiers associated with the one or more queries are stored in a database. The database includes gender information for the one or more entity identifiers. The entity tracking module 606 obtains the entity identifier and the gender of the entity identifier from the database.

In some implementations, the pronoun comparison module 602 compares a pronoun of query to the first entity identifier based on and a gender of the pronoun and the gender of the first entity identifier. The pronoun comparison module 602 compares the pronoun of a query to the second entity identifier based on and a gender of the pronoun and the gender of the second entity identifier. The entity identifier matching module 606 determines a match between the first entity identifier and the pronoun and/or a match between the second entity identifier and the pronoun.

For example, the first query is “who is Ben Affleck.” The second query is “what is his height.” The entity identifier of the first query is “Ben Affleck” and the gender of “Ben Affleck” is male. The pronoun of the second query is “his” and the gender of the pronoun is male. There is a match between “Ben Affleck” and “his,” because both the entity identifier and the pronoun are male. An example modified query 514 is “what is Ben Affleck height.”

In some implementations, the modified query 514 is adjusted to form a grammatically-correct modified query. A set of rules determines possessive pronouns and adjusts the modified query 514 to include a possessive. In the above example, the pronoun “his” is determined to be a possessive pronoun. The entity identifier “Ben Affleck” is adjusted in the modified query 514 to include the possessive to form a grammatically-correct modified query. An example grammatically-correct modified query is “what is Ben Affleck's height.”

As another example, the first query is “where is the Taj Mahal.” The second query is “when was it built.” The entity identifier of the first query is “Taj Mahal” and the gender of “Taj Mahal” is neuter. The pronoun of the second query is “it” and the gender of the pronoun is neuter. There is a match between “Taj Mahal” and “it,” because both the entity identifier and the pronoun are neuter. An example modified query 514 is “when was Taj Mahal built.”

In some implementations, the type of an entity identifier is recorded. The entity identifier is compared to a database comprising type information of entity identifiers to determine the type of the entity identifier. Examples of types of entity identifiers include a person type, a location type, and an organization type.

In some implementations, the animacy of the entity identifier is determined from a set of rules that map animacy to the type of the entity identifier. For example, an entity identifier of a person type is an animate entity identifier and an entity identifier of a location type is an inanimate entity identifier. An example query, containing a pronoun such as “he” or “she” that refers to an animate entity identifier, is modified to include an animate entity identifier.

In some implementations a set of rules determine the type of entity identifier associated with a pronoun. An example query, containing a pronoun such as “there” that refers to a location entity identifier, is modified to include a location entity identifier. In an example, an organization entity identifier includes an association with either singular or plural pronouns.

As another example, the first query is “who is Ben Affleck wife.” The second query is “when was she born.” The entity identifier of the first query is “Jennifer Garner,” because “Jennifer Garner” is an answer for the first query. The gender of “Jennifer Garner” is female. The pronoun of the second query is “she” and the gender of the pronoun is female. There can be a match between “Jennifer Garner” and “she,” because both the entity identifier and the pronoun are female. An example modified query 514 is “when was Jennifer Garner born.”

As another example, the first query is “who is Barack Obama.” The second query is “who is Michelle Obama.” The third query is “how old is he.” The entity identifier of the first query is “Barack Obama” and the gender of “Barack Obama” is male. The entity identifier of the second query is “Michelle Obama” and the gender of “Michelle Obama” is female. The pronoun of the third query is “he” and the gender of the pronoun is male. The pronoun can be compared to the second entity identifier and it is determined that “Michelle Obama” and “he” are of different genders. The pronoun can be compared to the first entity identifier and it is determined that “Barack Obama” and “he” are of the same gender. Based on the comparison, it is determined that “Barack Obama” and “he” are a match. An example modified query 514 is “how old is Barack Obama.”

In some implementations, queries of entity identifiers, popular slogans, and song lyrics that include pronouns can remain unmodified. For example, a database of entity identifiers, popular slogans, and song lyrics that include pronouns is maintained. A query containing a pronoun is compared to the database. If there is a match between the query containing the pronoun and an entry in the database, then the query remains unmodified.

For example, a first query is “who is Barack Obama” and a second query is “he man movie.” The second query contains a pronoun, but the second query remains unmodified because “he man” is an entity identifier of an action hero.

As another example, a first query is “what is Taj Mahal” and a second query is “just do it.” The second query contains a pronoun, but the second query remains unmodified because “just do it” is a popular slogan. As another example, a first query is “who is Michelle Obama” and a second query is “she practices her speech.” The second query contains a pronoun, but the second query remains unmodified because “she practices her speech” is a musical lyric of a popular song.

In some implementations, the entity identifiers, popular slogans, and song lyrics that include pronouns can be identified even if not maintained in a database. For example, results of a search engine can be examined, where a song lyric query can be determined by keeping a database of lyrics domains, and checking what fraction of the top results responsive to the query come from the lyrics domains. Entities can be determined from the results by checking the words in the query that co-occur in the same order in the text of most of the results.

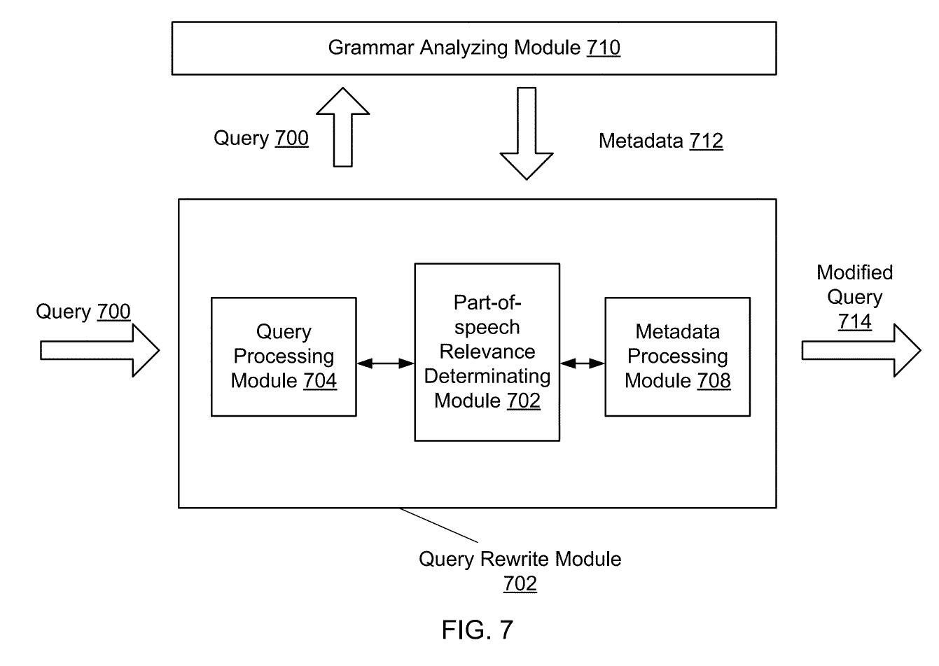

FIG. 7 illustrates another example query rewrite module 702. The example query rewrite module 702 can be, for example, any of the query rewrite modules 404, 406, 408, and 410 described above with reference to FIG. 4. As shown in FIG. 7, the query rewrite module 702 can return modified queries based on a query, that is, the query submitted by a user. Some implementations have different and/or additional modules than those shown in FIG. 7. Moreover, the functionalities can be distributed among the modules in a different manner than described here.

In some implementations, the example query rewrite module 702 includes a query processing module 704, part-of-speech relevance determining module 702, and a metadata processing module 708. The query processing module 704 receives a query 700. The query processing module 704 sends the query 700 to a grammar analyzing module 710.

The metadata processing module 708 receives metadata 712 identifying the part-of-speech and/or a grammatical relationship of one or more terms of the query 700. The part-of-speech can include a noun, a verb, etc. The grammatical relationship can include a direct object, an indirect object, etc.

In some implementations, the part-of-speech relevance determining module 702 determines the relevance of a term of query 700 based on the part-of-speech and/or the grammatical relationship of that term. In some implementations, a set of rules maps a part-of-speech and/or grammatical relationship to a statistical relevance of the part-of-speech and/or grammatical relationship to a quality of a search result. A part-of-speech and/or grammatical relationship of a term of query 700 is compared to the set of rules to determine the relevance of the term in the query 700. If a term of the query 700 is determined to have low relevance based on the part-of-speech and/or grammatical relationship, then the term can be removed when the query 700 is modified. If a term of the query 700 is determined to have high relevance based on the part-of-speech and/or grammatical relationship, then the term can remain when the query 700 is modified.

For example, if the query 700 is “show me pictures of cats,” metadata 712 identifying the part-of-speech and/or grammatical relationship of the query 700 is received and “show” is identified as a verb. “Me” is identified as an indirect object. “Pictures of cats” is identified as a direct object.

In some implementations, it is determined that the terms “show” and “me” have low relevance with respect to the query 700 based on the part-of-speech and the grammatical relationship, because “me” is an indirect object of the verb “show” and “me” is a first-person pronoun. It is determined that the terms “pictures of cats” have high relevance because “pictures of cats” is the direct object of the verb. For example, query 700 is modified by removing “show me” and keeping “pictures of cats” based on the relevance of the part-of-speech and the grammatical relationship of the terms of the query 700. An example modified query 714 is “pictures of cats.”

FIG. 8 illustrates an example method for generating modified queries. For convenience, the example method 800 will be described in reference to a system that performs method 800, e.g., a query-to-document-to-query, or QDQ, rewrite module. The QDQ rewrite module can be, for example, any of the query rewrite modules 404, 406, 408, and 410 described above with reference to FIG. 4. As shown in FIG. 8, the QDQ rewrite module can return one or more selected modified queries based on an initial query, that is, the query submitted by a user.

The QDQ rewrite module receives an initial query (802). The initial query can be received a number of different ways, including as a parameter or argument in a function call or as input during execution. The initial query can be natural language or query language and can be formatted as text, speech, or any other computer readable format. The initial query can include metadata, such as spelling corrections, synonyms, and part-of-speech tags. Once received, the initial query can be stored to memory or disk and used in subsequent processing.

The QDQ rewrite module determines a plurality of documents associated with the initial query (804). The plurality of documents can include HTML documents as well as any other computer readable documents, including text files.

Each of the plurality of documents is associated with the initial query. The nature of the associations can vary.

In some implementations, the QDQ rewrite module determines that documents are associated with the initial query where the documents are responsive to the initial query. A document can be associated with the initial query where it is associated with or part of a search result for the initial query or a similar or related query. Similarly, a document can be associated with the initial query where it is included in a list or table of relevant documents for the initial query or a similar or related query. The plurality of documents can be determined by requesting search results for the initial query, requesting documents associated with or part of search results for the initial query, and or retrieving stored search results or a stored list or table of relevant documents.

In some implementations, the system determines a fixed number of documents, e.g., 20. For example, the system can select the most relevant documents to the initial query. The relevancy of a document can be signified by a document relevancy score, search ranking, or other measure used for expressing document relevancy.

The QDQ rewrite module determines a plurality of candidate modified queries (806). More than one query per document could be determined to be a candidate modified query. The determination is accomplished by identifying queries that are associated with the plurality of documents. This can be based on popularity and relevance either alone or together or in combination with other factors.

The association between documents and candidate modified queries can be a two-way association. A document can be associated with a candidate modified query in a number of different ways. These include being associated with or part of a search result for the candidate modified query or a similar or related query, as well as being included in a list of relevant documents for the candidate modified query or a similar or related query. Additionally, a candidate modified query can be associated with a document. This can occur where the document is associated with or part of a search result for the candidate modified query or a similar or related query, the document is associated with or part of a popular result for the candidate modified query or a similar or related query, or the document is relevant to the candidate modified query.

The plurality of candidate modified queries could be dynamically generated or retrieved from storage. The plurality of candidate modified queries could be stored in a table or other data structure. The contents of the table or data structure could include references to documents and candidate modified queries associated with those documents.

In some implementations, the plurality of candidate modified queries is determined based on popularity. Here popularity involves determining the most popular query or queries for each of the plurality of documents. Popularity can be based on click-through data. The click-through data can include which documents were accessed, visited, or clicked on after a query. The click-through data can also include which query preceded a visit to, access to, or a click on a document. By processing the click-through data, one can determine how many times a document was accessed, visited, or clicked on following a particular query. The queries that preceded the highest number of access to, visits to, or clicks on the document would be the most popular queries and thus would be the candidate modified queries.

Consider the following scenario, hypothetical document D has been clicked on ten times. Five of the clicks were preceded by a search for hypothetical query A. Four of the clicks were preceded by a search for hypothetical query B. And one of the clicks was preceded by a search for hypothetical query C. In this scenario, query A would be the most popular and thus be selected as a candidate modified query. Additionally, query B was also popular and thus could be selected as a candidate modified query. Note that the above scenario is merely an example and is not intended to limit the scope of method 800.

In some implementations, the plurality of candidate modified queries is determined based on relevance. Here the associated queries that are most relevant to a document would be selected as candidate modified queries. Relevancy can be based on any of a number of factors, including popularity for the document (as discussed above), keyword matching, the document's rank for the query, the query quality, and overall popularity of the query.

Once the plurality of candidate modified queries has been determined, the QDQ rewrite module scores the plurality of candidate modified queries (808) by assigning one or more of them a query relevancy score. The query relevancy score can be determined based on the relevance of the plurality of documents that are associated with the candidate modified query to the initial query. Here, the relevance at issue is the relevance of each of the plurality of documents to the initial query. The relevance of a document to the initial query can be signified by a document relevancy score. A document relevancy score can be based on any number of factors including, keyword frequency, click-through data, document quality, time, length, incoming links, outgoing links, and many others. This could be computed dynamically or retrieved from a table or other data structure. Additionally other metrics could be used, including search ranking or other numeric and non-numeric measures of relevance.

Where a candidate modified query is associated with more than one of the plurality of documents, the query relevancy score can reflect the aggregated document relevancy scores of the associated plurality of documents. This can be computed by summing the document relevancy scores for the associated documents. Additionally, other methods of aggregation could be used, for example, multiplication and averaging. Further this approach would also be applicable to other relevance metrics.

In some implementations, the query relevancy score is based on the weight of the associated documents. In addition to a document relevancy score or measure, a document relevancy weight could be calculated or retrieved. The document relevancy weight could reflect the confidence of the document relevancy score or how much data the relevance was computed from. The relevancy weight could be used as a modifier for the document relevancy score. For example, a weighted document relevancy score could be created by multiplying the document relevancy score by the relevancy weight. Where the candidate modified query is associated with more than one document, the query relevancy score could be the weighted sum of the document relevancy scores. Further, other methods of aggregation could be used including weighted multiplication and weighted averaging.

In some implementations, the query relevancy score is also based on the prevalence of the candidate query. Here, prevalence refers to the proportion of the plurality of documents that are associated with the candidate modified query. For example, a candidate modified query that is associated with five documents would have a higher prevalence than a different candidate query that is only associated with two documents. One way to measure prevalence is dividing the number of documents associated with a candidate query by the total number of documents. A constant positive number could be added to the denominator to increase reliability. Additionally, other numeric and non-numeric measures can be used.

The query relevancy score can take many forms. It can be a single number or a set of numbers, each reflective of some aspect of relevance. Further, the query relevancy score could be one or more non-numeric measures.

The QDQ rewrite module identifies one or more selected modified queries from the plurality of candidate modified queries (810). The selection can be based on the query relevancy scores. This could be done a number of ways, including selecting one or more of the highest scoring candidate query or queries, or selecting all the candidate queries with query relevancy scores that satisfy a threshold.

In some implementations, the QDQ rewrite module filters the selected queries or the plurality of candidate modified queries. Filtering can be implemented to prevent the QDQ rewrite module from returning poor queries or queries that diverge too far from the initial query. In some implementations, the QDQ rewrite module filters by removing some of candidate or selected queries so that only a subset of them are returned. In some implementations, all the candidate or selected queries are removed and no candidate or selected queries are returned. Filtering could be done before or after scoring. The QDQ rewrite module can use any of the filters provided below as well as others that would be appropriate either alone or in combination.

One example filter is prevalence. Here, the QDQ rewrite module can exclude candidate or selected modified queries that have a prevalence score that fails to satisfy a threshold. The QDQ rewrite module can also exclude candidate or selected modified queries that are associated with fewer than a threshold number of documents.

Another example filter is the use of the initial query's nouns. Here, the QDQ rewrite module can exclude candidate or selected modified queries that are missing one or more nouns from the initial query. This could be relaxed for candidate or selected modified queries the contain synonyms for nouns in the initial query.

Another example filter is the use of subsequences or subsets of the initial query. Here, the QDQ rewrite module can exclude candidate or selected modified queries that are not subsequences or subsets of the initial query. This could be relaxed for candidate or selected modified queries the contain synonyms of words in the initial query.

Another example filter is the popularity of the initial query. Here, the QDQ rewrite module can exclude some or all of the candidate or selected modified queries where the initial query is a popular query for one or more of the plurality of documents. Popularity can be based on click-through data as described above.

The QDQ rewrite module returns one or more of the selected modified queries (812). The selected modified queries can be returned as data representing or indicative of the selected modified queries. The data representing or indicative of the selected modified queries can include text, such as the query terms, and/or memory references (that may or may not be encrypted) for the selected modified queries. The data representing or indicative of the selected modified queries can be a complete response or part of a response that includes additional related data. The additional related data can include one or more confidence measures, as described above with reference to FIG. 4.

The QDQ rewrite module can also store the selected modified queries to be used at a later time. The selected modified queries and any additional related data can be stored to memory or disk along with the initial query. Where the QDQ rewrite module later receives the same or substantially the same initial query, the selected modified queries and the any additional related data can be retrieved and returned without determining and selecting candidate queries. This can help to avoid duplicative processing and improve system performance. However, to ensure accuracy, the QDQ rewrite module can be configured to determine and select candidate modified queries where the time between the requests fails to satisfy a threshold. The threshold could be predetermined or dynamically generated.

The capabilities discussed above, allow the QDQ rewrite module to identify additional queries that are relevant to the initial query. This can be useful where the initial query contains words that are less relevant to retrieval. This can be true of natural language and speech queries. For example, the query “what's the weather like” can have poor results because a search system may treat the words “what's” and “like” as high relevance words, when they are low relevance words. One way to mitigate this is to identify other similar or related queries that yield superior results. The QDQ rewrite module accomplishes this by taking advantage of the relationships between documents and queries. Specifically, by determining documents that are associated with the initial query and then determining queries that are associated with those documents.

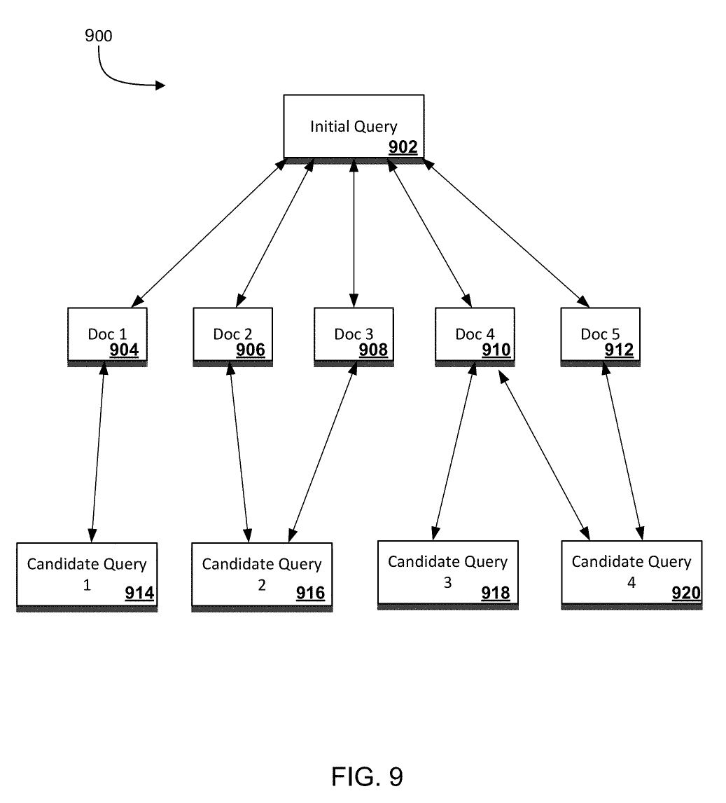

FIG. 9 illustrates an example mapping of associations of documents and queries 900 that can be determined in the above method for generating modified queries 800. Here, initial query 902 is associated with five documents (Doc 1-Doc 5 904-912). Each of the five documents (Doc 1-Doc 5 904-912) is associated with at least one candidate query (Candidate Query 1-4 914-920). Additionally, each of the four candidate queries (Candidate Query 1-4 914-920) is associated with at least one document (Doc 1-Doc 5 904-912). Note that example 900 is merely an example of a possible determination of method 800 and does not encompass the full scope of method 800.

As illustrated in FIG. 9, the arrangement of possible associations between documents and candidate queries can vary greatly. Documents and candidate queries can have a one-to-one relationship as shown by the association between Doc 1 904 and Candidate Query 1 914. Documents and candidate queries can have a many-to-one relationship as shown by the associations between Doc 2 906, Doc 3 908, and Candidate Query 2 916. Documents and candidate queries can have a one-to-many relationship as shown by the associations between Doc 4 910, Candidate Query 3 918, and Candidate Query 4 920. Documents and candidate queries can have a many-to-many relationship as shown by the associations between Doc 4 910, Doc 5 912, Candidate Query 3 918, and Candidate Query 4 920.

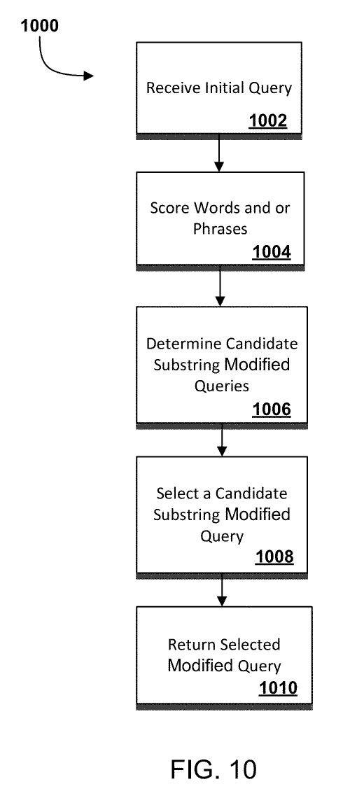

FIG. 10 illustrates another example method for generating modified queries. For convenience, the example method 1000 will be described in reference to a system that performs method 1000, e.g., a substring rewrite module. The substring module can be, for example, any of the query rewrite modules 404, 406, 408, and 410 described above with reference to FIG. 4. As shown in FIG. 10, the substring rewrite module can return one or more selected modified queries based on an initial query, that is, the query submitted by a user.

The substring rewrite module receives an initial query (1002). The initial query can be received a number of different ways, including as a parameter or argument in a function call or as input during execution. The initial query can be natural language or query language and can be formatted as text, speech, or any other computer readable format. The initial query can include metadata, such as spelling corrections, synonyms, and part-of-speech tags. Once received, the initial query can be stored to memory or disk and used in subsequent processing.

The substring rewrite module scores the words or phrases in the initial query (1004). This can involve assigning importance scores. The importance scores can be based on a number of factors, including inverse document frequency (IDF), part of speech, and the structure of the sentence as it relates to the word or phrase. These factors can be used in isolation or together and in addition to other factors. Algorithms for applying these factors could be implemented in the substring rewrite module. Alternatively, the algorithms for applying these factors could be implemented outside the substring rewrite module. Here the substring rewrite module could access the instrumentality applying the algorithms via a function call, an application-programing interface, or any other means of software interaction.

By scoring the words and phrases, the substring rewrite module can determine which words and phrases are most important in the initial query. For example, in the queries “show me sepia pictures of the Eiffel Tower” and “show me pretty pictures of the Eiffel Tower” the word “sepia” is important while the word “pretty” is not. The substring rewrite module can make this distinction by relying on IDF. “Sepia” has a higher IDF than “pretty”. Thus the substring rewrite module can correctly score “sepia” higher than “pretty.”

Similarly, the substring rewrite module can use part of speech information to determine importance. For instance, in the query “show me pictures of the Eiffel Tower,” “show” is not important. Conversely, “show” is important in the query “want to see a motor show.” This reflects the fact that nouns are typically more important to information retrieval than verbs. The substring rewrite module makes this distinction by relying on part of speech information.

The substring rewrite module generates and or determines a plurality of candidate substring modified queries (1006). This could include all possible combinations and permutations of the words or phrases in the initial query. Alternatively, the number of candidate substring modified queries could be limited to conserve resources. The number of candidate substring modified queries could be limited by only including those queries that contain all the important words or phrases from the initial query. A word or phrase can be deemed to be important where its score satisfies a threshold.

The substring rewrite module identifies one or more selected modified queries from the plurality of candidate substring modified queries (1008). A number of factors can be considered when identifying the selected modified queries, including how frequently the query is issued and similarity to the initial query. These factors can be used to create a score or a ranking for the candidate substring modified queries. The substring rewrite module can then select one or more of the candidate substring modified queries based on their rankings and or scores.

In some implementations, the substring rewrite module consults query logs and or a query frequency table to determine how frequently a query is issued. Query logs are records of issued queries. By counting the occurrence of a query in the logs, the substring rewrite module can determine how frequently a query is issued. Optionally, this could be processed offline by the substring rewrite module or another module or system and stored in a query frequency table that could be access by the substring rewrite module.

In some implementations, the substring rewrite module takes into account importance when determining the extent to which a candidate substring modified query is similar to the initial query. Here, important words or phrases could be assigned a greater weight based on their importance scores. Further, one method for assessing similarity could be to sum the importance scores, or some measure derived from the scores, for the words in the candidate modified query.

In some implementations, the substring rewrite module generates a metric that considers both how frequently a candidate substring modified query is issued and the importance of the words in that query. This can be done by coercing both into the range [0,1] and then taking a linear combination of them, to produce a score in the range [0,1].

The substring rewrite module returns one or more of the selected modified queries (1010). The selected modified queries can be returned as data representing or indicative of the selected modified queries. The data representing or indicative of the selected modified queries can include text, such as the query terms, and or memory references for the selected modified queries. The data representing or indicative of the selected modified queries can be data that has a begin index having characters or bytes of the original query and either an end index or a particular length. The data representing or indicative of the selected modified queries can be a complete response or part of a response that includes additional related data. The additional related data can include one or more confidence measures, as described above with reference to FIG. 4.

The capabilities discussed allow the substring rewrite module to identify additional queries that are relevant to the initial query and can be an improvement on the initial query. For instance, the query “show me pictures of the Eiffel Tower” returns results containing “show me”, which are not truly relevant. One way to mitigate this is to identify other similar or related queries that yield superior results. The substring rewrite module accomplishes this by identifying and removing less relevant words.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
receiving a first query;
obtaining first query results that are responsive to the first query;
determining that the first query results do not satisfy a requirement;
in response to determining that the first query results do not satisfy the requirement, obtaining one or more modified queries for the first query, including:
identifying a plurality of modified queries for the first query so that each of the modified queries are queries that are associated with one or more of the first query results, and each of the first query results are associated with one or more of the modified queries,
identifying a noun occurring in the first query, and
removing from the plurality of modified queries for the first query any modified queries that do not include the noun occurring in the first query;
selecting a modified query from the one or more modified queries for the first query remaining after the removing;
obtaining second query results that are responsive to the selected modified query; and
providing one or more of the second query results in response to receiving the first query.

2. The method of claim 1, wherein identifying the plurality of modified queries for the first query comprises:
identifying, for each query result of one or more query results of the first query results, a particular query that resulted in the highest number of selections for the query result; and
designating the particular query as a modified query for the first query.

3. The method of claim 1, wherein determining that the first query results do not satisfy the requirement comprises:
determining that a first query result of the first query results is associated with a ranking score that satisfies a threshold score;
determining that the first query results do not include any high quality answer within a first threshold number of first query results; or
determining that the first query results do not include any medium quality answer that is associated with a query intent of the first query within a second threshold number of first query results.

4. The method of claim 3, wherein the first query results do include a high quality answer but not within the first threshold number of first query results, and wherein the first threshold number is determined from a category associated with the high quality answer.

5. The method of claim 3, wherein the first query results do include a medium quality answer but not within a second threshold number of first query results, and wherein the second threshold number is determined from a category associated with the medium quality answer.

6. (canceled)

7. The method of claim 1, wherein selecting a modified query from the one or more modified queries comprises:
obtaining a confidence score for each of the one or more modified queries; and
selecting the modified query based on the confidence scores for each of the one or more modified queries.

8-9. (canceled)

10. The method of claim 1, wherein providing one or more of the second query results comprises:
presenting a hybrid list of query results, wherein the hybrid list includes query results from the first query results and from the second query results.

11. The method of claim 1, wherein identifying a plurality of modified queries for the first query comprises:
determining a plurality of documents associated with the first query;
determining a plurality of candidate modified queries, wherein each of the plurality of candidate modified queries is associated with at least one of the plurality of documents and each of the plurality of documents is associated with at least one of the plurality of candidate modified queries;
determining, for each of the plurality of candidate modified queries, a candidate score based on a relevance of the plurality of documents that are associated with the candidate modified query to the first query; and
identifying one or more modified queries from the plurality of candidate modified queries based on the respective candidate scores.

12. The method of claim 11, wherein the plurality of documents corresponds to query results associated with the first query.

13. The method of claim 11, wherein the plurality of documents are HTML documents.

14. The method of claim 11, wherein each of the plurality of documents is associated with a query result for a least one of the plurality of candidate modified queries.

15. The method of claim 11, wherein each of the plurality of candidate modified queries has associated query results that include at least one of the plurality of documents.

16. The method of claim 11, wherein each of the plurality of candidate modified queries is a popular query for at least one of the plurality of documents.

17. The method of claim 11, wherein the candidate score is based on a proportion of the plurality of documents that are associated with the candidate modified query.

18. The method of claim 11, wherein determining the candidate score based on the relevance of the plurality of documents that are associated with the candidate modified query to the first query comprises computing an aggregated document relevancy score using the relevance of each of the plurality of documents that are associated with the candidate modified query.

19. The method of claim 1, further comprising:
selecting more than one modified query from the modified queries; and
obtaining second query results that are responsive to the selected modified queries.

20. A system, comprising:
one or more computers and one or more storage devices storing instructions that are operable, when executed by the one or more computers, to cause the one or more computers to perform operations comprising:
receiving a first query;
obtaining first query results that are responsive to the first query;
determining that the first query results do not satisfy a requirement;
in response to determining that the first query results do not satisfy the requirement, obtaining one or more modified queries for the first query, including:
identifying a plurality of modified queries for the first query so that each of the modified queries are queries that are associated with one or more of the first query results, and each of the first query results are associated with one or more of the modified queries,
identifying a noun occurring in the first query, and
removing from the plurality of modified queries for the first query any modified queries that do not include the noun occurring in the first query;
selecting a modified query from the one or more modified queries for the first query remaining after the removing;
obtaining second query results that are responsive to the selected modified query; and
determining to provide one or more second query results as a result of the analyzing; and
providing one or more of the second query results in response to receiving the first query.

21. The system of claim 20, wherein identifying the plurality of modified queries for the first query comprises:
identifying, for each query result of the one or more query results of the first query results, a particular query that resulted in the highest number of selections for the query result; and
designating the particular query as a modified query for the first query.

22. The system of claim 20, wherein determining that the first query results do not satisfy the requirement comprises:
determining that a first query result of the first query results is associated with a ranking score that satisfies a threshold score;
determining that the first query results do not include any high quality answer within a first threshold number of first query results; or
determining that the first query results do not include any medium quality answer that is associated with a query intent of the first query within a second threshold number of first query results.

23. The system of claim 22, wherein the first query results do include a high quality answer but not within the first threshold number of first query results, and wherein the first threshold number is determined from a category associated with the high quality answer.

24. The system of claim 22, wherein the first query results do include a medium quality answer but not within the second threshold number of first query results, and wherein the second threshold number is determined from a category associated with the medium quality answer.

25. (canceled)

26. The system of claim 20, wherein selecting a modified query from the one or more modified queries comprises:
obtaining a confidence score for each of the one or more modified queries; and
selecting the modified query based on the confidence scores for each of the one or more modified queries.

27-28. (canceled)

29. The system of claim 20, wherein providing one or more of the second query results comprises:
presenting a hybrid list of query results, wherein the hybrid list includes query results from the first query results and from the second query results.

30. The system of claim 20, wherein identifying a plurality of modified queries for the first query comprises:
determining a plurality of documents associated with the first query;
determining a plurality of candidate modified queries, wherein each of the plurality of candidate modified queries is associated with at least one of the plurality of documents and each of the plurality of documents is associated with at least one of the plurality of candidate modified queries;
determining, for each of the plurality of candidate modified queries, a candidate score based on a relevance of the plurality of documents that are associated with the candidate modified query to the first query; and
identifying one or more modified queries from the plurality of candidate modified queries based on the respective candidate scores.

31. The system of claim 30, wherein the plurality of documents corresponds to query results associated with the first query.

32. The system of claim 30, wherein the plurality of documents are HTML documents.

33. The system of claim 30, wherein each of the plurality of documents is associated with a query result for a least one of the plurality of candidate modified queries.

34. The system of claim 30, wherein each of the plurality of candidate modified queries has associated query results that include at least one of the plurality of documents.

35. The system of claim 30, wherein each of the plurality of candidate modified queries is a popular query for at least one of the plurality of documents.

36. The system of claim 30, wherein the candidate score is based on a proportion of the plurality of documents that are associated with the candidate modified query.

37. The system of claim 30, wherein determining the candidate score based on the relevance of the plurality of documents that are associated with the candidate modified query to the first query comprises computing an aggregated document relevancy score using the relevance of each of the plurality of documents that are associated with the candidate modified query.

38. The system of claim 20, wherein the one or more computers are further configured to perform operations comprising:
selecting more than one modified query from the modified queries; and
obtaining second query results that are responsive to the selected modified queries.

39. A computer program product, encoded on one or more non-transitory computer storage media, comprising instructions that when executed by one or more computers cause the one or more computers to perform operations comprising:
receiving a first query;
obtaining first query results that are responsive to the first query;
determining that the first query results do not satisfy a requirement;
in response to determining that the first query results do not satisfy the requirement, obtaining one or more modified queries for the first query, including:
identifying a plurality of modified queries for the first query so that each of the modified queries are queries that are associated with one or more of the first query results, and each of the first query results are associated with one or more of the modified queries,
identifying a noun occurring in the first query, and
removing from the plurality of modified queries for the first query any modified queries that do not include the noun occurring in the first query;
selecting a modified query from the one or more modified queries for the first query remaining after the removing;
obtaining second query results that are responsive to the selected modified query; and
providing one or more of the second query results in response to receiving the first query.

40. The computer program product of claim 39, wherein identifying the plurality of modified queries for the first query comprises:
identifying, for each query result of the one or more query results of the first query results, a particular query that resulted in the highest number of selections for the query result; and
designating the particular query as a modified query for the first query.

41. The computer program product of claim 39, wherein determining that the first query results do not satisfy the requirement comprises:
determining that a first query result of the first query results is associated with a ranking score that satisfies a threshold score;
determining that the first query results do not include any high quality answer within a first threshold number of first query results; or
determining that the first query results do not include any medium quality answer that is associated with a query intent of the first query within a second threshold number of first query results.

42. The computer program product of claim 41, wherein the first query results do include a high quality answer but not within the first threshold number of first query results, and wherein the first threshold number is determined from a category associated with the high quality answer.

43. The computer program product of claim 41, wherein the first query results do include a medium quality answer but not within the second threshold number of first query results, and wherein the second threshold number is determined from a category associated with the medium quality answer.

44. (canceled)

45. The computer program product of claim 39, wherein selecting a modified query from the one or more modified queries comprises:
obtaining a confidence score for each of the one or more modified queries; and
selecting the modified query based on the confidence scores for each of the one or more modified queries.

46-47. (canceled)

48. The computer program product of claim 39, wherein providing one or more of the second query results comprises:
presenting a hybrid list of query results, wherein the hybrid list includes query results from the first query results and from the second query results.

49. The computer program product of claim 39, wherein identifying a plurality of modified queries for the first query comprises:
determining a plurality of documents associated with the first query;
determining a plurality of candidate modified queries, wherein each of the plurality of candidate modified queries is associated with at least one of the plurality of documents and each of the plurality of documents is associated with at least one of the plurality of candidate modified queries;
determining, for each of the plurality of candidate modified queries, a candidate score based on a relevance of the plurality of documents that are associated with the candidate modified query to the first query; and
identifying one or more modified queries from the plurality of candidate modified queries based on the respective candidate scores.

50. The computer program product of claim 49, wherein the plurality of documents corresponds to query results associated with the first query.

51. The computer program product of claim 49, wherein the plurality of documents are HTML documents.

52. The computer program product of claim 49, wherein each of the plurality of documents is associated with a query result for a least one of the plurality of candidate modified queries.

53. The computer program product of claim 49, wherein each of the plurality of candidate modified queries has associated query results that include at least one of the plurality of documents.

54. The computer program product of claim 49, wherein each of the plurality of candidate modified queries is a popular query for at least one of the plurality of documents.

55. The computer program product of claim 49, wherein the candidate score is based on a proportion of the plurality of documents that are associated with the candidate modified query.

56. The computer program product of claim 49, wherein determining the candidate score based on the relevance of the plurality of documents that are associated with the candidate modified query to the first query comprises computing an aggregated document relevancy score using the relevance of each of the plurality of documents that are associated with the candidate modified query.

57. The computer program product of claim 39, wherein the instructions when executed by the one or more computers cause the one or more computers to perform further operations comprising:
selecting more than one modified query from the modified queries; and
obtaining second query results that are responsive to the selected modified queries.
